(19) United States
(12) Patent Application Publication
(10) Pub. No.: US 2010/0276919 A1
(43) Pub. Date: Nov. 4, 2010

(54) SECURITY SHEET COMPRISING A COEXTRUDED MEDIUM

(75) Inventor: Philippe Dietemann, Saint-Martin-d'Heres (FR)

Correspondence Address: OLIFF & BERRIDGE, PLC, P.O. BOX 320850, ALEXANDRIA, VA, 22320-4850, US

(73) Assignee: Arjowiggins Security

(21) Appl. No.: 12/746,708

(22) PCT Filed: Dec. 19, 2008
(86) PCT No.: PCT/FR2008/052388

§ 371 Date: Jun. 7, 2010

(30) Foreign Application Priority Data
Dec. 28, 2007 (FR) 0760449

(51) Int. Cl. B42D 15/00; B32B 37/14; B26D 3/00; B32B 27/20; B29C 55/00; B44F 1/14; B44F 1/12; B44F 1/10

(52) U.S. Cl. 283/74; 156/163; 428/67; 428/159; 428/137; 428/138; 428/63; 428/29; 428/30; 264/46.1; 264/442; 264/482; 428/57

(57) ABSTRACT

A sheet including a coextruded medium made from at least one polymer material, including a core layer and at least one skin layer, the core layer including voids, the sheet having intaglio printing performed thereon.

The present invention relates to security sheets, and more particularly those made from at least one polymer material.

### BACKGROUND

At present, security documents such as banknotes are made for the most part on the basis of paper substrates. Such substrates present numerous advantages: in particular they render printing very well, and they are compressible, which enables intaglio printing in relief to be performed, and they present good resistance to tearing from a tear starter.

The intaglio printing technique is well known in the state of the art, in particular for printing papers of value such as banknotes, checks, and other similar documents.

In that technique, a printing plate is engraved to form a predetermined design and the engraving, corresponding to recesses, is subsequently filled with ink that is then transferred onto the print medium, which is deformed by the pressure, e.g. using a cylinder.

The surface that penetrates into the engraving is thus marked with the ink that had previously been deposited therein.

U.S. Pat. Nos. 5,062,359 and 5,899,145 describe examples of printing machines using the intaglio printing method.

There also exist security documents, in particular banknotes, that are made of plastics material. Compared with paper documents, documents made of plastics material have the advantage of presenting better durability, in particular because of their low porosity, their resistance to moisture, to grease, and to other agents that are likely to accelerate document aging.

Australian patent application AU 488 652 describes a security medium for fabricating banknotes comprising a substrate made of an opaque thermoplastic material that is bonded to a woven or non-woven fabric, in particular a polyamide grid, thereby contributing to three-dimensional stability. The substrate is printed and includes optically-variable security elements.

International application WO 83/00659 describes a security sheet comprising a substrate made from a film of a bi-axially oriented transparent polymer that is coated in layers of opaque material, which layers are applied in such a manner as to leave a transparent zone enabling security documents incorporated in the polymer film to be observed.

The plastics material substrates presently in use nevertheless present several drawbacks.

A first drawback is that they are not really suitable for intaglio printing since that involves high pressures. Unfortunately, the intaglio printing method is in widespread use in the field of security documents, and in particular for banknotes.

A second drawback is that substrates made of plastics material generally present lower resistance to tearing from tear starters than do substrates made of paper.

Furthermore, another drawback of substrates made of plastics material is that the quality of printing often degrades as a result of the plastics material document being handled.

As a result, even though present plastics material security documents have a lifetime that is relatively long compared with paper security documents in terms of ability to withstand dirtying and tearing other than from tear starters, that advantage is limited because other characteristics, such as the appearance of printing, degrade quickly.

Patent application FR 2 816 643 describes a complex security medium comprising two polyester films having a non-woven fabric inserted between them, the fabric being made up of fibers that withstand tearing mechanically and that withstand heat. The polyester films and the non-woven fabric preferably include security elements.

Such a medium presents resistance to tearing from tear starters that is equal to that of paper, printability characteristics that are compatible with intaglio printing, good print durability, and also good ability to withstand high temperatures. Nevertheless, that medium is complex to make.

EP 0 655 316 A2 discloses an extruded sheet of polymer material having a pseudo-watermark made thereon.

EP 0 470 760 A2 discloses a sheet comprising three coextruded layers, including a core layer that presents voids and two skin layers respectively on either side of the core layer.

### SUMMARY

There exists a need to provide a security sheet that is adapted to intaglio printing.

There also exists a need to provide a security sheet that comprises a medium of plastics material that offers very good rendering of printing and excellent durability for printing.

There also exists a need to provide a security sheet of plastics material of appearance and feel that are close to those of paper.

There also exists a need to further diversify security sheets in order to produce novel effects, both in terms of appearance and/or to obtain greater security.

The invention seeks to satisfy these needs in full or in part.

In one of its aspects, the invention provides a sheet comprising a coextruded medium made from at least one polymer material, comprising a core layer and at least one skin layer, the core layer including voids, the sheet having intaglio printing performed thereon.

The term “core layer”, also referred to as a “base layer”, should be understood as meaning that this layer of the medium is further from the surface of the sheet that receives the intaglio printing than is the “skin layer”, also referred to as a “surface layer”. The skin layer may optionally define an outside face of the sheet, the medium possibly being covered at least in part in a coating for the purpose of improving the durability of printing, for example.

The Applicant has shown that the poor printability of previously-used plastics-material media is due to the poor compressibility of such media. A sheet of the invention presents the advantage of being compressible because of the presence of voids in the core layer. As a result, it is entirely suitable for the intaglio printing method and any other treatment that gives rise to a tactile effect. The sheet may present printing in relief equivalent to that obtained on a sheet of paper, together with details that are very sharp.

Preferably, the intaglio printing is performed on a surface that enhances printing. For example, when the medium is covered in an outer coating, the intaglio printing is preferably performed on the coating.

Another advantage of a sheet of the invention is that it provides excellent rendering of printing together with good contrast, thereby enabling fine structures to be printed sharply thereon, where such structures are difficult for counterfeiters to reproduce.

Yet another advantage of a sheet of the invention is that it may present print durability and mechanical properties that are improved compared with a sheet of paper.

In another of its aspects, the invention also provides a security sheet comprising a coextruded medium made from at least one polymer material, comprising a core layer and at least one skin layer, the core layer including voids, at least one of the layers of the medium including a security element embedded therein. By way of example, this may be the core layer or the skin layer, or both simultaneously.

Such a sheet may be provided with a great variety of security elements, and may thus present a relatively high level of security.

In another of its aspects, the invention also provides a sheet comprising a coextruded medium made from at least one polymer material, comprising a core layer placed between two skin layers, the core layer including voids, and the two skin layers presenting different colors, when illuminated in light that is visible or invisible.

Such a sheet presents the advantage of being relatively difficult to reproduce because of the presence of the skin layers of different colors and also because it produces novel effects in terms of appearance. When the sheet is observed in reflection, each of the skin layers has a different color. In contrast, when the sheet is observed in transmission, another color may appear, depending in particular on the colors of the skin layers, and providing the medium is made to be somewhat transparent.

In another of its aspects, the invention provides a security sheet including at least one first region provided with optical means and at least one second region provided with a security element of appearance that differs depending on whether it is observed directly or through optical means, the first region being disposed on the sheet so as to overlie the security element when the sheet is folded in half.

The sheet may be made in such a manner that after folding, at least one item of information is revealed when the sheet is observed through a transparent region thereof.

### DESCRIPTION OF THE FIGURES

The invention can be better understood on reading the following description of non-limiting embodiments thereof, and on examining the accompanying drawings, in which:

FIGS. 1 and 2 are face views showing two examples of security sheets of the invention;

FIGS. 3 and 4 are likewise face views showing two other examples of security sheets of the invention, each provided with a transparent portion;

FIGS. 5 and 6 are diagrammatic and fragmentary views in cross-section showing security sheets of the invention;

FIG. 7 is a face view of the FIG. 6 sheet seen looking along VII;

FIGS. 8 and 9 are face views of a security sheet of the invention shown respectively in the unfolded state and when folded in half; and

FIGS. 10 and 11 are diagrammatic and fragmentary cross-section views showing various examples of security sheets of the invention.

In the figures, the elements constituting security sheets are not always drawn to scale, in order to clarify the drawings.

### SHEET AND CORRESPONDING MEDIUM

FIG. 10 is a section view of an example sheet 1 of the invention comprising a coextruded medium 2.

As shown, the medium 2 may comprise a core layer 10 with skin layers 11 and 12 on either side thereof.

The medium 2 need not be completely opaque.

The base layer 10 includes voids 14, which may result from the core layer being stretched during extrusion, e.g. using bi-axial stretching.

The medium 2 may be covered at least in part, on at least one face, in a coating 13.

The sheet 1 may have received one or more intaglio prints 20, e.g. on the coating 13, which coating may, for example, be applied on one of the skin layers at least for the purpose of imparting satisfactory printability properties thereto.

For example, the coating includes a binder, such as a mixture of butyl acrylate, styrene, and acrylonitrile polymers, together with fillers, such as silicoaluminate and/or aluminum hydroxide.

The sheet may also include a coating possessing not only printability properties but also anti-dirtying properties and/or improved durability, for example being as described in application EP 1 319 104. By way of example, at least one of the skin layers of the medium may be covered in a transparent layer comprising colloidal silica and a binder, e.g. a polyurethane.

The medium and/or the sheet may also include a protective varnish.

The intaglio printing may be performed at a pressure lying in the range 180 bars to 220 bars, e.g. being equal to about 200 bars.

The intaglio-printed ink may for example be an ink that is phosphorescent, luminescent, photochromic, thermochromic, etc., and it is preferably a fluorescent ink.

The size of the relief obtained by intaglio printing may be greater than or equal to 20 micrometers (μm), e.g. being as great as 30 μm or even 35 μm, compared with about 15 μm for a prior art plastics-material medium.

The medium 2 may be made from at least one polymer material, preferably at least one polyolefin, e.g. a polyethylene or a polypropylene.

By way of example, the core layer 10 may comprise a mixture of orientable thermoplastic polyolefin with at least one resinate, in particular a metallic resinate, e.g. based on calcium and zinc, constituting 2% to 50% by weight relative to the weight of the mixture, the polyolefin being a high density polyethylene, for example. The resinate may include a separate phase, that is uniformly distributed in the olefin polymer, as disclosed in EP 0 470 760 A2.

The composition of the core layer may be for example as specified in EP 0 470 760 A2, namely (proportions by weight):

| | |
|---|---|
| H polyethylene (copolymer) | 100 |
| resinate, in particular calcium-zinc | 5-15 |
| polystyrene | 4.5-5.5 |
| HD polyethylene (homopolymer) | 17.5-21 |
| calcium carbonate | 15-25 |
| titanium dioxide | 5-10 |
| styrene-butadiene copolymer | 0-1.0 |
| calcium oxide | 0.4-1.0 |

By way of example, the medium presents the following formulation:

Base layer (e.g. about 80 μm thick)

| Constituent elements | Parts |
|---|---|
| HDPE copolymer | 100 |
| HDPE homopolymer | 17.6 |
| Polystyrene | 4.8 |
| Rosin resin | 6.0 |
| Styrene-butadiene-styrene copolymer | 0.6 |
| CaCO₃ | 21.0 |
| TiO₂ (rutile) | 5.8 |
| Antistatic, antioxidant, . . . agents | 1.4 |

Skin Layers (e.g. about 8 μm Thick)

| Constituent elements | Parts |
|---|---|
| HDPE copolymer | 100 |
| HDPE homopolymer | 9.9 |
| TiO₂ (rutile) | 15 |
| Calcium stearate | 0.1 |

Each skin layer 11 or 12 may comprise a polyolefin and a mineral filler, in particular a silica. Each skin layer 11 or 12 may include 10% to 50% by weight of mineral filler, relative to the weight of the mixture.

At least one of the skin layers may include at least three thermoplastic polymer materials including a rubbery polymer, with at least two of the materials having at least a certain degree of incompatibility.

At least one skin layer may thus comprise a composition comprising a high density polyethylene and a low density polyethylene or a copolymer of propylene and a rubbery polymer. The copolymer may be selected from thermoplastic copolymers of butadiene and styrene, copolymers of isobutylene and isoprene, and terpolymers of ethylene, propylene, and diene.

The core layer 10 may be thicker than each of the skin layers 11 or 12. The core layer 10 may have thickness greater than 10 μm, better greater than 50 μm, better still greater than 75 μm, and each skin layer may have a thickness less than 50 μm, better less than 15 μm, better still less than 10 μm. The medium 2 may have a total thickness lying in the range 70 μm to 120 μm, for example.

The core layer 10 includes voids 14 as mentioned above. The volume percentage of voids in the medium 2 may lie in the range 2% to 7%, and preferably in the range 4% to 6%, relative to the total volume of the medium. The skin layers 11 and 12 are preferably free of any voids that open out into their surfaces.

The void volume of the medium may be determined after cutting the medium with a beam of ions (e.g. argon ions), thus limiting the appearance of scratches, filling, tears, or compression of the medium so as to preserve its morphology, thus better determining its porosity.

After cutting the medium, it may be observed using an electron microscope, in particular a scanning electron microscope, e.g. of the ESEM Quanta 200 type from EFPG. It is then possible to observe in the various layers of the medium, the core layer and the skin layers, their porosities, and the security elements, if any.

The void volume percentage may be calculated as the ratio of the total area of voids present in the section over the total area of the section, using the following formula:

$$φ = 〈 {\overline{P}}_{s} 〉 = \frac{{S}_{void}}{{S}_{section}}$$

The various layers of the medium may be coextruded at a temperature lying in the range 150° C. to 250° C., for example.

The surface of the medium may be subjected to oxidation by corona type electric discharge treatment. Such treatment serves to obtain a polar surface having the required wettability for easily accepting inks and coatings that the medium is to receive subsequently.

Application EP 0 470 760 discloses methods of fabricating a medium that is suitable for the invention.

### PROPOSED EXAMPLES

### Example 1

Reference is made to examples 1 to 4 described in EP 0 470 760 A2. The corresponding sheets were intaglio-printed on one face.

### Example 2

A sheet of Polyart® HS 90 or Polyart® HS 115 from the supplier Arjobex was printed on one face using intaglio printing.

Medium with a Through Opening

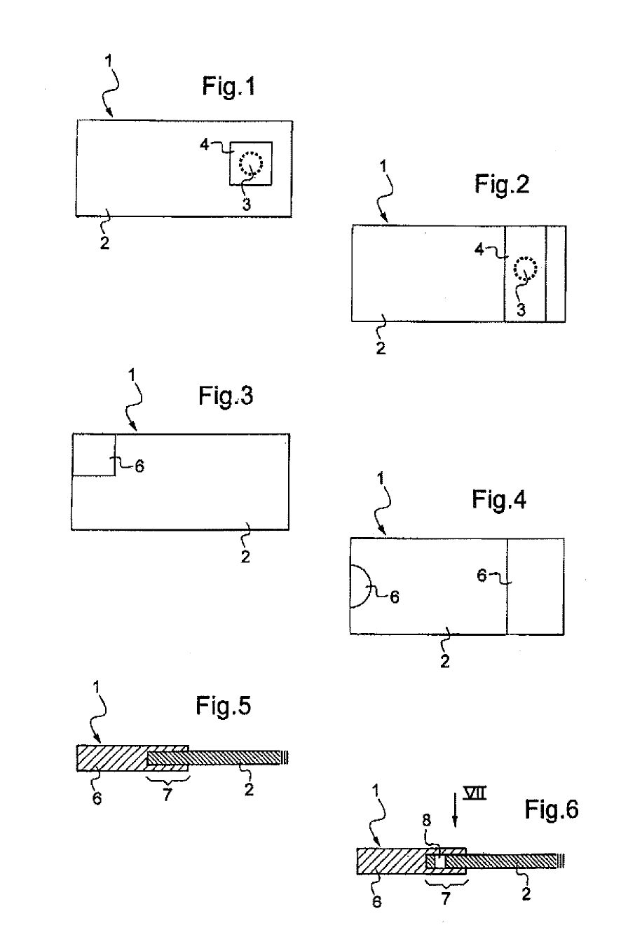

The medium 2 may present at least one through opening 3, as shown in FIGS. 1 and 2.

By way of example, the opening(s) 3 in the medium may be made by: stamping, punching, using a laser, using ultrasound, or cutting with a fluid jet, e.g. a water jet.

The through opening 3 is preferably situated close to at least one edge in a lateral zone of the sheet, i.e. away from the middle zone of the sheet. This characteristic is particularly advantageous when the sheet is to be folded. Under such circumstances, the sheet presents a degraded zone corresponding to the fold zone, generally a middle zone. It is then advantageous for the through opening 3, which may constitute a weak zone, to be off-center relative to the middle zone.

The through opening 3 may present an area lying in the range 1 square centimeter (cm²) to 10 cm², and preferably in the range 3 cm² to 5 cm².

The through opening 3 may present a geometrical shape such as a circle, an oval, or a polygon, in particular a square, or it may have the shape of an alphanumeric character, or of a logo.

The opening 3 may be covered on at least one side of the medium 2 by at least one element 4 made of plastics material, preferably material that is at least partially transparent, so as to form a transparent but non-through window in the sheet 1. This element 4 may form a patch, as shown in FIG. 1, or it may extend in the form of a strip, e.g. in the width direction, from one edge to the other of the sheet 1, as shown in FIG. 2.

In particular, the opening 3 is covered on both sides of the medium by respective elements 4.

Where appropriate, the element 4 may constitute optical means enabling a security element to be observed and enabling a characteristic thereof to be revealed. The element 4 may possess dimensions that are slightly greater than the dimensions of the through opening 3, thus making it easier to fasten on the medium 2.

The element 4 may be of thickness lying in the range 5 μm to 20 μm, for example.

The element 4 may present extra thickness in register with the through opening 3.

Where appropriate, the element 4 may include fluorescent pigments or ink that are/is transparent in visible light and that manifest their effect under ultraviolet (UV) light. Since the medium is opaque to UV, the fluorescent effect of the element 4 is observable through the through opening 3 regardless of which face of the medium is observed, and regardless of whether the illumination source is placed in front of or behind said face. In contrast, the fluorescent effect will be fully visible for regions of the element 4 lying away from the opening 3 only when the medium is observed from the face of said medium that includes the element 4, and with the illumination source situated on the same side as the face that includes the element 4. The fluorescent effect is visible for the regions of the element 4 that lie away from the opening 3 with an attenuated effect when the medium is observed from the face that does not have the element 4, with the illumination source still situated on the same side as the face including the element 4.

The medium may include a through opening 3 that is covered in an element 4 having fluorescent pigments or ink in the form of a strip on one of the faces of the medium, the medium itself being printed on its other face using a fluorescent ink in the zone situated in register with the element 4.

The through opening 3 may also be covered by two elements 4, only one of them including fluorescent pigments or ink, or indeed both of them may include fluorescent pigments or ink of colors that are different.

For example, the medium includes at least one through opening 3, and the opening 3 is covered on one of its faces by a strip of transparent plastics material 4 including a fluorescent ink of yellow color and on its other face by a strip of transparent plastics material 4 including a fluorescent ink of blue color. Thus, since the medium is opaque to UV, a different fluorescent color will be observed for the strips 4 on each side of the medium, and a white color that results from combining the two fluorescent colors will be observed in the through opening 3.

In another example, the through opening 3 is covered on both sides by respective elements 4, each presenting extra thickness in register with the through opening 3, each extra thickness being substantially equal to half the thickness of the medium, for example, and projecting towards the inside of the opening. Such a configuration serves to avoid the elements 4 deforming over the through opening, and furthermore, where appropriate, can enable the two elements 4 to be assembled together through the opening 3, which may reinforce their retention on the medium 2.

At least one security element may optionally be located between the elements 4, e.g. so as to observable from outside the sheet.

The flat elements 4 may be colored, where appropriate. Two elements 4 having different colors may be fastened on opposite faces of the medium.

The medium may also include at least one through opening used for fastening a transparent portion that projects from the medium, as described below.

Sheet with One or More Transparent Portions

The sheet may present a projecting portion 6 made of at least one transparent plastics material, referred to below as the “transparent portion”, and as shown in FIGS. 3 and 4.

In the example of FIG. 3, the sheet 1 comprises the medium 2 together with a transparent portion 6 forming one corner of the sheet 1.

In the example of FIG. 4, the sheet 1 comprises the medium 2 together with two end transparent portions 6. One of these portions defines the entire end edge of the sheet 1, and the other defines a semicircle in the opposite edge.

FIG. 5 is a cross-section of a junction zone 7 between the medium 2 and the end transparent portion 6.

The end transparent portion 6 may cover the medium 2 on both faces, thereby improving the strength of the junction, as can be seen in the figure.

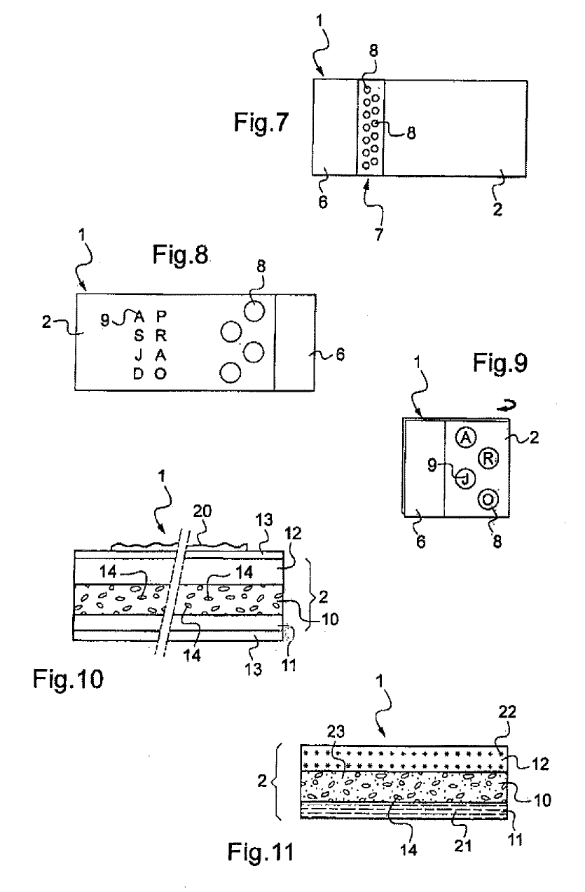

As shown in FIGS. 6 and 7, the medium 2 may be provided with at least one non-through recess or with a through opening 8 in the junction zone 7 between the medium 2 and the end transparent portion 6. This or these opening(s) 8 serve to further reinforce the strength of the junction 7, in particular when the medium 2 and the transparent portion 6 are covered in an adhesive that diffuses through the opening(s) 8.

In the particular configuration where the transparent portion includes a zone that overlies opposite faces of the medium, and the medium includes openings in this overlap zone, the transparent portion may diffuse through the medium, thereby strengthening the structure as a whole. The bonding through openings may be provided either by the transparent zone melting and solidifying, or by a reaction between two compositions that are to be found respectively on the faces of the transparent layers or films that come into contact, e.g. a two-component adhesive or a pressure-sensitive adhesive, or an adhesive based on synthetic or natural isoprene (natural rubber), having the property of bonding to itself.

In the overlap zone, the adhesive and/or the transparent portion may contain one or more security elements on one or both faces that come into contact with the other medium.

The transparent portion may include at least one additional security element.

In particular, the additional security element may be embedded and/or it may be on the surface of the transparent portion.

The transparent portion may in particular include holograms or other optical effect elements, in particular variable effect elements.

The transparent portion may include security elements, in particular elements selected from luminescent and/or iridescent pigments and fibers, magnetic fibers, and mixtures thereof.

The transparent portion 6 may include a film of at least one polymer material, where appropriate made of adhesive, the film being laminated or backed on the medium 2, for example.

The transparent portion 6 may be an extruded or coextruded layer of one or more polymers.

For example, the transparent portion 6, like the above-mentioned element 4, may be made of a material selected from:

1) addition-polymerized resins such as:
a) polyolefin resins, possibly of varying densities and having varying degrees of ramification, such as for example: polyethylene; polypropylene; polymethylpentene;
b) elastomer resins such as for example: ethylene-propylene-diene monomers, poly(acrylonitrile-butadiene-styrene), poly(styrene-butadiene-styrene), polybutadiene, polyisoprene;
c) vinyl resins such as for example: poly(vinyl chloride), poly(vinyl acetate), poly(vinyl ethylene-acetate), poly(vinyl ethylene-alcohol);
d) halogenated resins such as, for example: poly(vinyl chloride), polychloroprene, poly(vinylidene chloride), polytetrafluoroethylene;
e) styrene resins such as, for example: polystyrene, poly(acrylonitrile styrene), poly(styrene-butadiene-styrene);
f) acrylic resins such as, for example: poly(methyl methacrylate), polyacrylonitrile, poly(acrylonitrile-butadiene-styrene), poly(methyl ethylene-acrylate); and
g) ionomer resins;

2) condensation polymerized resins such as:
a) polyester resins such as, for example: poly(ethylene terephthalate), poly(butylene terephthalate), poly(ethylene glycol terephthalate), glycerophtalic resins;
b) polyamide resins;
c) polycarbonate resins;
d) polyurethane resins;
e) polyimide resins;
f) polyacetal resins, such as for example: polyvinylbutyral;
g) polyether resins, such as for example; polyoxymethylene;
h) epoxy resins;
i) aminoplast resins;
j) phenoplast resins; and
k) silicone resins; and

3) resins derived from natural cellulose such as:
a) viscose;
b) cellulose acetate.

The transparent portion may be covered at least in part in a layer that is printable and/or that encourages the adhesion of ink. For example, the transparent portion may be made printable by depositing a coating containing a binder such as a styrene-acrylic polymer and mineral fillers.

The transparent portion may also receive surface treatment, in particular of the corona type.

The transparent portion may be covered, at least in part, in a layer possessing anti-dirtying and/or printability properties. For example, the transparent portion may be covered in a transparent layer comprising colloidal silica and a binder, e.g. a polyurethane.

The transparent portion 6 may represent 20% to 40% of the total area of a face of the sheet.

Preferably, the sheet is such that the transparent portion extends from one side to the other of the medium in the overlap zone between the transparent zone and the medium. This serves to provide better cohesion for the sheet and to reinforce the strength of the junction between the transparent zone and the medium.

In a preferred embodiment of the invention, the overlap zone between the medium and the transparent portion does not present any perceptible extra thickness, e.g. being practically imperceptible to the touch. For example, the sheet may be of substantially constant thickness, of the order of 100 μm to make a banknote. More particularly, in the overlap zone, the transparent portion and/or the medium may present thickness that is reduced relative to their respective thicknesses in the remainder of the sheet.

Openings Co-Operating with Patterns and/or Security Elements of the Sheet

The opening(s) in the medium may co-operate with visible characters that are mentioned or that appear on at least one of the faces of the sheet, in such a manner as to reveal information when the sheet is folded.

More particularly, at least one opening may co-operate with at least one visible character, mentioned or appearing on the recto face of the sheet, in order to reveal first information when the sheet is folded one way, and to co-operate with at least one visible character mentioned or appearing on the verso face of the sheet, the character(s) being identical or different from the character(s) on the recto face, in order to reveal second information that may be identical with or different from the first information, when the sheet is folded the other way.

The term “visible” means that the characters can be perceived directly by the human eye, and also that the characters may be made visible to the human eye with the help of a magnifying appliance (a magnifying glass, a microscope, a thread counter) and furthermore, possibly after they have been excited using radiation, in particular ultraviolet or infrared radiation.

FIGS. 8 and 9 show another example of a sheet 1 of the invention likewise including a transparent portion 6, which may cover at least one opening 8 in the medium 2, e.g. on both faces, in the junction zone 7.

At least one pattern is printed on the medium 2, e.g. one or more characters 9, such that, when the sheet 1 is folded in half, the character(s) 9 is/are visible through the opening(s) 8.

The sheet may be such that it includes at least two security elements situated respectively on the surface of the medium and in a through opening, or in a transparent zone covering the through opening, the two security elements being placed in such a manner as to overlie each other when the security sheet is folded, so as to form additional security or information.

For example, a first security element may be a lenticular array covering a second security element constituted by a scrambled image, which is revealed when the two security elements overlie each other.

In another example, a first security element is a polarizing filter and a second security element is made using liquid crystals, so as to enable an image associated with the liquid crystals to be revealed by the filter.

### Security Elements

In general terms, security documents and/or certificates are known that include security elements enabling such documents to be protected against attempts at falsification or at counterfeiting.

Amongst security elements, some are detectable by the naked eye, in visible light, and without using any particular appliance. Such security elements include for example colored flakes or fibers.

Such security elements are said to be “first level” elements.

Other types of security elements are detectable only with the help of some relatively simple appliance such as a lamp that emits in the ultraviolet or the infrared. Such security elements comprise for example fibers, flakes, or particles. These security elements may optionally be visible to the naked eye, e.g. being luminescent under a Wood lamp emitting at a wavelength of 365 nanometers (nm). These elements may also be of the thermochromic or photochromic type, for example.

These security elements are said to be “second level” elements.

The detection of still other types of security element requires a more sophisticated detection appliance. By way of example, such security elements are capable of generating a specific signal when subjected in optionally simultaneous manner, to one or more external excitation sources. Automatic signal detection enables the document to be authenticated, where appropriate.

By way of example, these security elements comprise tracers in the form of active material, particles or fibers, capable of generating a specific signal when the tracers are subjected to optoelectronic, electrical, magnetic, or electromagnetic excitation.

These security elements are said to be “third level” elements.

All of the above-mentioned security elements may be used in the context of the present invention. At least one skin layer and/or the core layer and/or the coating of the medium may include at least one such security element of the first, second, or third level.

The core layer and/or at least one skin layer and/or the coating may include a security element that is embedded therein and/or that is at its surface.

The respective security elements of the skin layers, of the core layer, and of the coating may all be different from one another, or in a variant they may all be identical.

The core layer may present a concentration of security elements that is greater than in the other layers, given that it is further away from the surface.

The security elements may be incorporated in the medium prior to the medium being extruded, so that they are dispersed throughout the material of at least one of the layers of the medium.

The presence of security elements in a sheet of the invention may enable substantially opaque zones to be obtained without any need to print on the sheet. As a result, this may constitute an alternative to conventional printing performed on plastics medium of the prior art.

At least one security element, e.g. in the form of a thread, may also be incorporated between two layers, e.g. between a skin layer and the core layer.

In the example of FIG. 11, security elements 21, 22, and 23 are embedded in the material of the layers constituting the skin 11, the core 10, and the skin 12, the security elements 21, 22, and 23 being, for example, different for each of the three layers but identical within any one layer. In a variant, a single layer may include different security elements.

The two skin layers may each include a respective security element, with the security elements of the first skin layer being different from the security elements of the second skin layer.

At least one security element may be in the form of a strip or a thread.

At least one security element may be a security thread, a foil, a patch, a flake, a pseudo-watermark, a knitted thread, so-called “tagging” marking particles, security fibers, and/or a combination of such elements.

As examples of marking particles, mention may be made in particular of the following associations:

a) Altair pigment from the supplier Verismo LLC placed in a layer encouraging printing, e.g. a skin layer including a coating; and

b) Datatrace DNA pigment from the supplier Datatrace placed in the surface layer(s); or when the medium includes at least two surface layers:

a) Spot Tag pigment from the supplier BSecure placed in one of the surface layers; and

b) Altair pigment from the supplier Verismo LLC placed in the other surface layer.

In general, the security element may be selected from the following marking particles:
Spot Tag from the supplier BSecure;
Datatrace DNA from the supplier Datatrace;
black powders from the supplier Microtag;
IR Regulus 93, IR Regulus 39, Lanthanide derivative, Sirius or Altair from the supplier Verismo; and
“tagging” elements sold by the supplier Payne Security.

At least one security element may also correspond to an authentication and/or identification element selected from at least one of the following elements: an element for revealing falsification, in particular an element that is visible and/or detectable with the help of a specific detector device; an element presenting a variable, interference, and/or diffractive, holographic, iridescent, or liquid crystal optical effects; a magnetic or crystalline coating; magnetic fibers; tracers that are detectable by magnetic resonance; tracers that are detectable by X-ray fluorescence; biomarkers; a varnish or an ink; tracers that are luminescent, fluorescent, or phosphorescent; compounds that are photochromic, thermochromic, electroluminescent, and/or piezochromic, and/or that change color on contact with one or more predetermined chemical or biochemical substances; and electronic devices, in particular radiofrequency identification (RFID) chips.

At least one security element may be selected from fibers and/or inks and/or pigments that are luminescent, e.g. being visible solely under UV or laser radiation, and/or iridescent, magnetic fibers, and/or metallic fibers, and mixtures thereof. Preferably, such a security element is present embedded in the core layer and/or in a skin layer and/or in a coating.

At least one security element may be an element that is thermochromic, piezochromic, or photochromic.

At least one security element may be a particle that is luminescent, in particular fluorescent.

At least one security element may be a marking particle containing a fragment of DNA.

The sheet may include all types of security element, in particular on the surface.

At least one security element may be a metallic film that is removed in part and/or that presents visual effects, e.g. holographic effects, and that is situated on the surface of the medium.

At least one security element may be a metallic layer situated at the surface of at least one portion of the medium. In particular, the metal layer may be partially covered in an opaque layer, so as to form patterns.

At least one security element may be a pattern formed on zones that are more translucent than the medium and that appear like a watermark, e.g. made using the method described in patent application. EP 1 518 861.

At least one security element may be a flat element made of a specific material that collects light (a “waveguide”) that is situated at the surface of the medium. Such luminescent light-collecting materials that are suitable may for example be polymer films based on polycarbonate, known as Lisa®, and sold by the supplier Bayer.

Preferably, the flat element made of a specific material that collects light includes patterns that are etched, embossed, or printed, in particular negative patterns at the surface, that enable the luminescence to be observed at least in the patterns.

### PROPOSED EXAMPLES

### Example 3

A security sheet was made using Altair pigment from Verismo LLC in the coating for enhancing printing deposited on the medium, and the Datatrace DNC pigment from Datatrace was used in the two skin layers of the medium.

### Example 4

A security sheet was made with the Spot Tag pigment from BeSecure in one of the skin layers of the medium and the Altair pigment in the other skin layer of the medium.

### Colored Multilayer Medium

The sheet may comprise a coextruded medium having for example the above-defined characteristics, with the core layer being placed between two skin layers of different colors.

The various color components are defined in the CIE1976 (L*, a*, b*) colorimetric space also known as CIELAB. The value a* corresponds to the position on the red/green axis and the value b* corresponds to the position on the blue/yellow axis. Saturation C* corresponds to the quantity (a*²+b*²)^{1/2}. The hue angle h corresponds to the quantity arctan(a*/b*). L* designates lightness.

In an embodiment of the invention, at least one of the surface layers presents lightness L* greater than 70, in particular 80 or 90.

If so desired, one of the skin layers may present color having saturation C* less than 50, in particular 35 or 20, so as to appear, in reflection, as having a subtle, weakly saturated color.

One of the skin layers may incorporate at least one coloring agent in its material.

The coloring agent may be of any type, e.g. being selected from a direct dye, an acid dye, a basic dye, an organic or mineral pigment, this list not being limiting.

The above-mentioned colors may be due to different coloring agents and/or to different concentrations present respectively in the materials of the two skin layers.

Where appropriate, the sheet may include a coating layer including at least one coloring agent, the skin layers and the coating layer having different colors.

The skin layers may define the outside faces of the sheet and these faces may present, in reflected visible light, colors that are different, in particular with saturations and/or hue angles that are different.

One of the skin layers may include a first fluorescent zone capable of fluorescing under predefined lighting conditions so as to emit visible light of a first color, and the other layer may include a second fluorescent zone capable of fluorescing under the same predefined lighting conditions, to emit visible light of a second color that is different from the first.

An article including such a structure or sheet may be authenticated and/or identified by performing two observation steps on two respective opposite faces of the article, thereby reinforcing the protection of the article against falsification.

The predefined lighting conditions may correspond to ultraviolet lighting, e.g. at a wavelength that is close to the visible, e.g. close to 365 nm. In a variant, the predefined lighting condition corresponds to infrared lighting.

### PROPOSED EXAMPLE

### Example 5

A security sheet, e.g. of the Polyart® type was made with a transparent or translucent medium having its skin layers that were modified by introducing coloring agents so that they appeared respectively yellow and cyan blue.

In transmitted light, the sheet thus appeared to have a color corresponding to combining the respective colors of those two layers, i.e. a green color, that is different from the colors of the two layers when viewed in reflected light.

### Security Article

The invention also provides an article, in particular a security document and/or a certificate or a packaging device that includes a sheet as defined above.

In particular, the article may be selected from: an identity document; payment means such as a check or a banknote; an identity card; a passport booklet or sheet; a visa; a coupon; a protective and/or authentication label; a traceability label; a letterhead; an advertising shot; amongst others.

### Authentication Method

In another of its aspects, the invention also provides a method of authenticating and/or identifying an article including a sheet as defined above, the method comprising the following steps:
observing at least one security element present within the medium or on the medium of the sheet; and
coming to a conclusion about the authenticity and/or the identity of the article at least on the basis of said observation.

In another of its aspects, the invention also provides a method of authenticating and/or identifying an article including a sheet as defined above, the method comprising the following steps:
observing the color of one of the skin layers in reflected light;
observing the color of the other skin layer in reflected light; and
observing in transmitted light the color that results from superposing the colors of the skin layers.

The authenticity and/or the identity of the article may be deduced at least from the colors observed in the above steps.

Naturally, the invention is not limited to the embodiments descried above.

The term “comprising a” should be understood as being synonymous with “comprising at least one” unless specified to the contrary.

1-52. (canceled)

53. A sheet comprising a coextruded medium made from at least one polymer material, comprising a core layer and at least one skin layer, the core layer including voids, the sheet having intaglio printing performed thereon.

54. A sheet comprising a coextruded medium made from at least one polymer material, comprising a core layer and at least one skin layer, the core layer including voids, at least one of the layers of the medium including a security element embedded therein.

55. A sheet comprising a coextruded medium made from at least one polymer material, comprising a core layer placed between two skin layers, the core layer including voids, and the two skin layers presenting different colors.

56. A sheet according to claim 53, the polymer material comprising at least one polyolefin.

57. A sheet according to claim 56, the polymer material comprising at least a polyethylene or a polypropylene.

58. A sheet according to claim 53, the core layer comprising a mixture of orientable thermoplastic polyolefin with at least one resinate constituting 2% to 50% by weight relative to the weight of the mixture.

59. A sheet according to claim 58, the core layer comprising a mixture of a high density polyethylene with at least a metallic resinate constituting 2% to 50% by weight relative to the weight of mixture.

60. A sheet according to claim 53, the skin layer comprising a polyolefin with a mineral filler.

61. A sheet according to claim 60, the mineral filler being a silica filler.

62. A sheet according to claim 53, the core layer having a thickness greater than or equal to 10 μm.

63. A sheet according to claim 62, the thickness being greater than or equal to 50 μm.

64. A sheet according to claim 63, the thickness being greater than or equal to 75 μm.

65. A sheet according to claim 53, the skin layer(s) having a thickness less than or equal to 50 p.m.

66. A sheet according to claim 65, the thickness being less than or equal to 15 μm.

67. A sheet according to claim 66, the thickness being less than or equal to 10 μm.

68. A sheet according to claim 53, the medium having a total thickness lying in the range 70 μm to 120 p.m.

69. A sheet according to claim 53, the void volume in the medium lying in the range 3% to 7%.

70. A sheet according to claim 53, including at least one coating covering at least part of a face of the medium.

71. A sheet according to claim 70, each of the two faces of the medium being covered at least in part in a coating.

72. A sheet according to claim 70, the coating imparting printability properties to the sheet.

73. A sheet according to claim 53, the medium including at least one through opening.

74. A sheet according to claim 73, said at least one through opening being situated in an end zone of the sheet.

75. A sheet according to claim 73, the through opening having an area lying in the range 1 cm² to 10 cm².

76. A sheet according to claim 75, the area lying in the range 3 cm² to 5 cm².

77. A sheet according to claim 53, including a transparent portion comprising a transparent plastics material.

78. A sheet according to claim 77, the transparent portion being provided at least in part with a coating that is printable and/or that encourages the adhesion of ink.

79. A sheet according to claim 73, including a transparent portion in the form of an element covering the through opening.

80. A sheet according to claim 79, the through opening being covered by two elements, each covering at least part of a face of the medium.

81. A sheet according to claim 79, the element being in the form of a patch.

82. A sheet according to claim 79, the element being in the form of a strip extending from one edge to an opposite edge of the medium.

83. A sheet according to claim 79, the element presenting extra thickness in register with the through opening.

84. A sheet according to claim 79, the element having thickness lying in the range 5 μm to 20 μm.

85. A sheet according to claim 77, the transparent portion forming at least part of an end zone of the sheet.

86. A sheet according to claim 77, the transparent portion occupying 20% to 40% of the total area of a face of the sheet.

87. A sheet according to claim 77, the transparent portion extending on either side of the medium in an overlap zone between the transparent portion and the medium.

88. A sheet according to claim 87, the overlap zone between the medium and the transparent portion presenting no perceptible extra thickness.

89. A sheet according to claim 87, the transparent portion and/or the medium including at least one non-through recess or at least one opening in the overlap zone.

90. A sheet according to claim 89, including at least one opening overlying at least one visible character when the sheet is folded in half.

91. A sheet according to claim 77, the sheet including at least two security elements situated respectively firstly covering the medium and secondly in a through opening of the medium or in a transparent portion overlying the through opening.

92. A sheet according to claim 91, the two security elements being placed in such a manner as to overlie each other when the security sheet is folded in half, in order to form a security feature or to reveal information.

93. A sheet according to claim 54, the sheet having intaglio printing performed thereon.

94. A sheet according to claim 53, the intaglio printing comprising an ink that is phosphorescent, luminescent, photochromic, thermochromic, or fluorescent.

95. A sheet according to claim 53, the intaglio printing forming relief having a thickness of more than 20 μm.

96. A sheet according to claim 53, at least one skin layer and/or the core layer and/or a coating covering the medium at least in part including at least one security element.

97. A sheet according to claim 96, the security element being embedded and/or on the surface of the corresponding layer.

98. A sheet according to claim 96, including respective different security elements in the skin layers, the core layer, and in the coating.

99. A sheet according to claim 96, the core layer presenting a greater concentration by weight of security elements than the skin layers or the coating.

100. A sheet according to claim 96, the security element present within the medium being a security thread, a foil, a patch, a flake, a knitted thread, a “tagging” marking particle, a pseudo-watermark, a security fiber, and/or a combination of these elements.

101. A sheet according to claim 96, the security element present within the medium corresponding to an authentication and/or identification element selected from at least one of the following elements: an element for revealing falsification, an element that is visible and/or detectable with the help of a specific detector device; an element presenting a variable, interference, and/or diffractive, holographic, iridescent, or liquid crystal optical effects; a magnetic or crystalline coating; magnetic fibers; tracers that are detectable by magnetic resonance; tracers that are detectable by X-ray fluorescence; biomarkers; a varnish or an ink; tracers that are luminescent, fluorescent, or phosphorescent; compounds that are photochromic, thermochromic, electroluminescent, and/or piezochromic, and/or that change color on contact with one or more predetermined chemical or biochemical substances; and electronic devices, radiofrequency identification (RFID) chips.

102. A sheet according to claim 96, the security element present within the medium being selected from fibers and/or inks and/or pigments that are luminescent, and/or that are iridescent, magnetic fibers, and/or metallic fibers, and mixtures thereof.

103. A sheet according to claim 96, the security element present within the medium being an element of a specific material that collects light, the element being situated at the surface of the medium.

104. A sheet according to claim 53, the skin layers having different colors.

105. A sheet according to claim 55, the skin layers appearing, in reflection, to have different colors and the sheet appearing, in transmitted light, to have a color that corresponds to superposing the respective colors of the two skin layers.

106. A sheet according to claim 53, including a coating covering a skin layer at least in part and including at least one coloring agent, the skin layer and the coating having colors that are different.

107. A method of fabricating a sheet according to claim 53, wherein the medium of the sheet is stretched.

108. A method according to claim 107, wherein the medium is stretched bi-axially.

109. A method according to claim 108, a portion made of transparent plastics material being fastened to the medium.

110. A method according to claim 109, the portion made of transparent material being an extruded or coextruded polymer film.

111. A method according to claim 109, the portion made of transparent material being fastened to the medium by pressure adhesion, chemical adhesion, backing or lamination.

112. A method according to claim 107, at least one through opening being cut in the medium, by laser, by punch, by ultrasound, or by cutting with a fluid jet.

113. A method according to claim 107, the security element being introduced in the material of the medium prior to the medium being extruded.

114. An article comprising a sheet according to claim 53, said article being selected from: an identity document; payment means; an identity card; a passport booklet or sheet; a visa; a coupon; a protection and/or authentication label; a traceability label; a letterhead paper; or an advertising shot.
